(19) United States
(12) Patent Application Publication
(10) Pub. No.: US 2006/0048179 A1
(43) Pub. Date: Mar. 2, 2006

(54) Method and system to access PC-based services from non-PC hardware

(76) Inventors: Philip Ted Kortum, Austin, TX (US); Marc Andrew Sullivan, Austin, TX (US); James L. Cansler JR., Pflugerville, TX (US); Alyssa Lenorah Noll Williams, Elmhurst, IL (US)

Correspondence Address: MATTHEW E. BURR;LAKE AUSTIN MARINA, 2219 WESTLAKE DR, STE 200, AUSTIN, TX, 78746, US

(21) Appl. No.: 10/927,954

(22) Filed: Aug. 27, 2004

(51) Int. Cl. H04N 7/16; H04N 7/167; H04N 7/10; H04N 7/025

(52) U.S. Cl. 725/30; 725/36; 725/31; 725/25

(57) ABSTRACT

An authentication protocol interface is described that allows a user to authenticate into, or login to, a PC based environment using a non-pc device. It also provides the user with a transparent method of “programming” the interface so that the interface behaves the way a user wants the next time they use the system. The invention further enables a user to avoid authentication altogether by allowing the settop box to serve as the login authority for certain tasks. The invention operates in a non-PC environment where the use of a mouse and other MS Windows® interface components (i.e., check boxes, radio dials, and the like) are not allowed.

### FIELD OF THE INVENTION

The invention relates to content display systems, and more particularly, to methods and systems for accessing content from a PC environment such as Windows® or MAC OS with non-PC hardware, such as a cable or satellite television settop box.

### BACKGROUND

Digital transmission technology enables cable and satellite television systems to deliver much more than the traditional analog broadcast content. So-called “enhanced programming” is implemented in many homes by the digital home communication terminal (“DHCT”), otherwise known as the settop box. The DHCT has become an important computing device for accessing video services and navigating a subscriber through a maze of available services.

DHCTs support an increasing number of services. Many of the services are not merely broadcast viewing content, but are interactive two-way communications. An example of such two-way communication is video-on-demand service. New services also include e-mail or web browser display and use. A host of other television services is available and is anticipated to become important in the market: audio and audio/visual programming, advanced navigation controls, impulse pay-per-view technology, and on-line ecommerce. In addition to the interactive services, increased bandwidth available through a digital television system makes it possible for a subscriber to have access to hundreds, or even thousands, of channels, services, features, and activities. Computer servers with PC architecture and in a PC software environment, such as Windows,® will deliver many of these things to the DHCT. To access the powerful and complex features that are becoming available, a subscriber will need to be able to enter the PC environment through the DHCT.

Wireless remote controls, many of them programmable, are used to access the DHCT. Accordingly, a remote control that programs the DHCT or otherwise accesses the PC content available through the DHCT, is desired. The present invention provides a system having a DHCT, a wireless remote control and a television so that a viewer can access PC content, such as is available with Windows® or MAC OS through the television by programming the DHCT with the remote control.

### BRIEF DESCRIPTION OF THE DRAWING

The present invention is further described in the detailed description that follows, by reference to the noted drawing, by way of non-limiting examples of embodiments of the present invention, in which reference numerals represent parts throughout the drawing, and in which:

FIG. 1 is a block diagram of an authentication protocol process of one embodiment of the present invention.

### DETAILED DESCRIPTION

In view of the foregoing, the present invention, through one or more of its various aspects, embodiments and/or specific features or sub-components, is thus intended to bring out one or more of the advantages that will be evident from the description. The present invention is described with frequent reference to television. It is understood, however, that television is merely an example of a specific embodiment of the present invention, which is directed generically to authenticating into a PC content environment from a non-PC environment, within the scope of the invention. The terminology, examples, drawings and embodiments, therefore, are not intended to limit the scope of the invention.

The present invention provides an interface program that allows a user to authenticate into, or login to, a PC based environment using a non-pc device. It also provides the user with a transparent method of “programming” the interface so that the interface behaves the way a user wants the next time they use the system. The invention further enables a user to avoid authentication altogether by allowing the settop box to serve as the login authority for certain tasks. The invention works in a non-PC environment where the use of a mouse and other MS Windows® interface components (i.e., check boxes, radio dials, and the like) are not allowed.

Typical computer login authentication methods make ready use of the mouse and other MS Windows® interface components such as checkboxes, radio dials, double-clicking and so forth. In non-PC environments, like video set top boxes, for example, the user does not have access to a mouse and standard keyboard. In cases like these, a user navigates and manipulates the interface using a remote control, which severely limits the kind of actions the user can take.

The present invention provides for easy manipulation of the interface with a remote control to accomplish the task of logging on to a PC-based service from a non-PC device within the limitations of the remote. The invention further contains features (intelligent population of fields and directed dialog queries) that allow the user to “program” the interface to work in a fashion that supports the user's desires. At the user's option, the invention also allows the device itself to serve as a ‘master’ to allow access to pc-based services without user intervention.

For example, an owner of a video settop box uses one login method embodiment of the invention when they wanted to access Yahoo®'s LaunchCast® Music Service. The invention allows a user who was already a LaunchCast® user to login (with varying levels of security) using their existing LaunchCast® username and password or allow the settop box itself to serve as the master login authority. The second option would allow any authorized settop owner to access an approved service without the need for the user to already be a registered user (with a separate username and password) of that service.

PC-based services include pages retrieved of the world wide web (the “Web”) from primary or proxy internet servers, as well as peer-to-peer file sharing between personal computers, email services such as Hotmail®, ecommerce services such as eBay® and Amazon.com,® and audio/visual content such as that accessible with Windows® media, Realplayer,® Quicktime® and the like. It should further be noted that the present invention contemplates video settop boxes for cable, satellite and high definition television, including settop boxes having digital video recording and related functions.

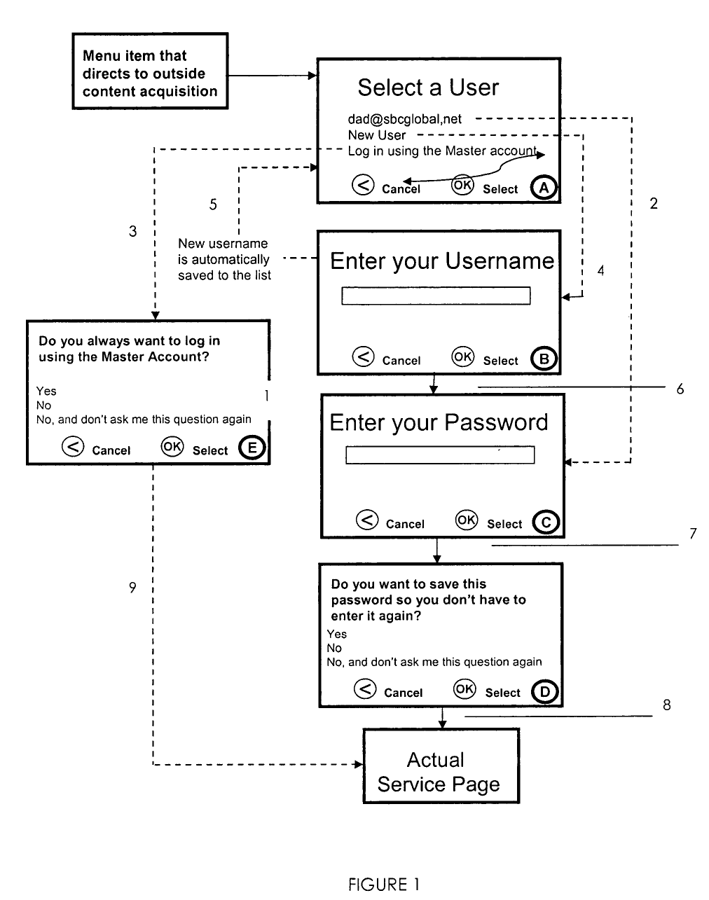

FIG. 1 is a block diagram of an authentication protocol process of one embodiment of the present invention.

The interface displays Screen A when, at step 1, a user has navigated the interface to a page that allows access to a pc-based service. Screen A presents a prompt for a user to select a user name. The interface presents at least two choices for a user that has never used this part of the interface. The user selects either a user name (step 2), or selects—from Screen E—for the device to serve as the master at step 3.

In the event that the user has an account for the pc-based service of interest, she can select the ‘new user’ option from Screen A at step 4. This action elicits a prompt to enter the user name for that service in Screen B. The DHCT automatically saves the username in step 5 and then automatically populates it into the user selection dialog (Screen A) for the next use.

Once a user has keyed in or selected a username, the interface takes the user to Screen C at step 6, which prompts the user for a password. To accomplish actions such as entering a username or other alphanumeric characters, various embodiments of the invention provide a remote control, or functionally equivalent device, that includes an alphanumeric keyboard to input the username and password characters. In a specific embodiment, the keyboard is provided under a flip-open compartment of the device. Another embodiment provides a keyboard on the face of the device, similar to that provided by Blackberry® and equivalent devices. Alternative embodiments provide a “soft” keyboard that is displayed on the television screen, for example, and which is navigated with standard remote control buttons, such as direction arrows, to select and input the username characters.

After entry of the password, Screen D of the interface prompts (step 7) the user to select whether to save the password to streamline the login process for subsequent uses. The user can select yes or no. An additional option is to ‘program’ the system by to prompt for a password at each login session, but not to present the password screen each time.

Following successful username/password authentication on the pc-based service, the DHCT retrieves (step 8) the URL of desired service, and the displays the service's webpage on the television monitor. The user navigates the service's web site in customary fashion with the remote control, or functionally equivalent device, of the present invention.

In the scenario of Screen A where the user chose the option for the device to login as the master (thereby bypassing the need to have a separate login or account), the user is taken (step 9) to Screen E rather than through the login steps of screens B-D. Screen E ‘programs’ the interface either to always have the DHCT to login as the master without prompt, or for the user make the master selection on a case by case basis.

The result is an interface that allows the user to
a) go directly to the pc-based service page without any intervention if they choose “login as master” on screen A and selected ‘yes’ on Screen E;
b) require full username and password entry for each user; or
c) use any level of logon security in-between these two extremes.

The invention achieves the flexible result in a way that is easily supported by a remote control or equivalent device. Note that there are no check boxes or similar mouse-based manipulations or inputs required. The user simply scrolls down to the correct action and presses a button on the remote.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in all its aspects. Although the invention has been described with reference to particular means, materials and embodiments, the invention is not intended to be limited to the particulars disclosed; rather, the invention extends to all functionally equivalent technologies, structures, methods and uses such as are within the scope of the appended claims.

We claim:

1. A system comprising:
a PC-based content source;
a content display module;
a wireless remote control; and
a programmable non-PC-based medium networked to the PC-based content source, wherein the non-PC-based medium accepts program input from the remote control and outputs content to the display module according to the input program, and wherein the programmable non-PC-based medium reads computer code that programs the medium to perform programmed functions, wherein the functions comprise:
displaying on the display module a PC-based content login interface;
logging into the PC-based content; and
displaying the PC-based content display on the display module.

2. The system of claim 1, wherein the non-PC-based medium comprises a DHCT.

3. The system of claim 2, wherein the DHCT comprises a satellite television settop box.

4. The system of claim 2, wherein the DHCT comprises a cable television settop box.

5. The system of claim 2, wherein the DHCT comprises a high definition television settop box.

6. The system of claim 1, wherein the content display module comprises a television monitor.

7. The system of claim 5, wherein the television comprises a high definition television monitor.

8. The system of claim 1, wherein the PC-based content source comprises the Web.

9. The system of claim 1, wherein the remote control comprises an alphanumeric keyboard.

10. The system of claim 1, wherein the interface provides a soft keyboard.

11. The system of claim 1, wherein the PC-based based content source comprises a personal computer.

12. The system of claim 11, wherein the personal computer runs Windows® operating system.

13. The system of claim 11, wherein the personal computer runs MAC OS.

14. A user interface displayed on a television screen connected to a DHCT to access content from a personal computer or internet server through the DHCT, wherein the interface accepts user information from a remote control, the interface comprising:
a menu item to select a user account from a list of users, wherein at least one user account is a master account, for the user to login to the computer content source;
a master account window for the user to optionally login with the master account every time;
a username window to enter a new user into the user list;
a password window to enter a user password; and
a password save window for the user to optionally save a password.

15. A DHCT remote control comprising an alphanumeric keyboard.

16. A method for authenticating a non-PC user into PC-based content, the method comprising:
providing a PC-based content source;
providing a content display module;
providing a wireless remote control; and
providing a programmable non-PC-based medium networked to the C-based content source, wherein the non-PC-based medium accepts program input from the remote control and outputs content to the display module according to the input program, and wherein the programmable non-PC-based medium reads computer code that programs the medium to perform programmed functions, wherein the functions comprise:
displaying on the display module a PC-based content login interface;
logging into the PC-based content; and
displaying the PC-based content display on the display module.

17. A method for authenticating a non-PC user into PC-based content, the method comprising the steps of:
displaying on a display module a PC-based content login interface;
logging into the PC-based content; and
displaying the PC-based content on the display module.
